(19) United States
(12) Patent Application Publication
(10) Pub. No.: US 2018/0015761 A1
(43) Pub. Date: Jan. 18, 2018

(54) METALLIC LUSTER IMAGE RECORDING METHOD

(71) Applicant: CANON KABUSHIKI KAISHA, Tokyo (JP)

(72) Inventor: Atsushi Miida, Kawasaki-shi (JP)

(21) Appl. No.: 15/545,736

(22) PCT Filed: May 24, 2016
(86) PCT No.: PCT/JP2016/065846

§ 371 Date: Jul. 24, 2017

(30) Foreign Application Priority Data
May 28, 2015 (JP) 2015-108940

(51) Int. Cl. B41M 5/00; B41J 11/00

(52) U.S. Cl. CPC B41M 5/0064; B41M 5/0047; B41M 5/0023; B41M 5/0017; B41J 11/0015

(57) ABSTRACT

A method of recording an image including an uneven surface having metallic luster on a recording medium, the method including the steps of forming on a recording medium a surface uneven layer of a cured product produced by irradiating an active energy ray curable material with an active energy ray; forming an ink absorbing layer on the surface uneven layer; and applying to the ink absorbing layer an ink containing flaky particles for imparting metallic luster by an ink jet method. The method enables recording of an image including an uneven surface having metallic luster with excellent brilliance even on a surface uneven layer with low absorbability of a solvent ink containing flaky particles.

### TECHNICAL FIELD

The present invention relates to a method of recording an image including an uneven surface having metallic luster.

### BACKGROUND ART

Images can have various textures by imparting a region having surface unevenness with metallic luster to a print surface in addition to a color image, and there is a demand for a printer capable of reproducibly forming such images having surface unevenness with metallic luster.

As a method of forming surface unevenness with metallic luster, PLT 1 discloses a method of forming metallic luster surfaces with different luster levels. In this method, an ink jet recording apparatus or a similar apparatus is used to form, on a recording medium, a surface uneven layer and a metallic luster layer in this order while the arithmetic average roughness on the surface uneven layer is controlled, forming such a metallic luster surface. PLT 2 discloses a method of recording an image having brilliance and abrasion resistance. In the method, a resin ink in which a resin component is dispersed or dissolved in a dispersion medium is used to form a receptive underlayer having surface unevenness on an ink non-absorbable or ink poorly-absorbable recording medium, and an aqueous brilliant ink is used to form such an image on the receptive underlayer.

### CITATION LIST

### Patent Literature

PLT 1: Japanese Patent Application Laid-open No. 2010-030139

PLT 2: Japanese Patent Application Laid-open No. 2012-035590

### SUMMARY OF INVENTION

### Technical Problem

The image recording method of the present invention is
a method of recording an image including an uneven surface having metallic luster on a recording medium, and the method includes the steps of:
forming on a recording medium a surface uneven layer of a cured product produced by irradiating an active energy ray curable material with an active energy ray, forming an ink absorbing layer on the surface uneven layer, and
applying to the ink absorbing layer an ink containing flaky particles for imparting metallic luster by an ink jet method.

In the present invention, an ink containing flaky particles for imparting metallic luster is applied to an ink absorbing layer provided on a surface uneven layer of a cured product cured with an active energy ray, forming an unevenness having metallic luster. At this application, the ink absorbing layer rapidly adsorbs the ink to form a metallic luster layer in which flaky particles for imparting metallic luster are aligned on the ink absorbing layer. This enables the recording of an image having a metallic luster uneven surface with excellent brilliance.

Further features of the present invention will become apparent from the following description of exemplary embodiments with reference to the attached drawings.

### BRIEF DESCRIPTION OF DRAWINGS

FIG. 1 is a configuration view of an example of an ink jet recording apparatus.

FIGS. 2A1, 2A2, 2A3, 2A4, 2B1, 2B2, 2B3 and 2B4 are schematic views illustrating image expressions controlled by area gradation.

FIGS. 3A, 3B, 3C, 3D and 3E are views explaining movement of a liquid ejection head which performs scanning on a recording medium to form a surface uneven layer, an ink absorbing layer, a metallic luster layer, and a color image.

FIG. 4 is a schematic cross-sectional view of a multilayer structure including a surface uneven layer, an ink absorbing layer, and a metallic luster layer formed on a recording medium.

### DESCRIPTION OF EMBODIMENTS

Preferred embodiments of the present invention will now be described in detail in accordance with the accompanying drawings.

When an ink is used to form a metallic luster surface on a surface uneven layer provided on a recording medium, an intended metallic luster surface having brilliance cannot be obtained in some cases depending on a combination of materials constituting the surface uneven layer and a formulation of the ink. For example, even if an ultraviolet ray curable ink containing an acrylic monomer is used to form a surface uneven layer composed of an acrylic cured resin, and an ink containing scaly aluminum-containing particles is used to form a metallic luster layer on the surface uneven layer, the brilliance cannot be improved.

An object of the present invention is to provide a metallic luster image recording method that enables the recording of an image including a metallic luster uneven surface having excellent brilliance even on a surface uneven layer having poor absorbability of an ink that contains flaky particles for imparting metallic luster.

The inventors of the present invention have studied the reason why brilliance cannot be improved when a solvent ink containing scaly aluminum-containing particles is used to form a metallic luster surface on a surface uneven layer of an acrylic cured resin formed by using an ultraviolet ray curable liquid material. As a result, the reason is supposed to be that the surface uneven layer of the cured resin formed by using the ultraviolet ray curable liquid material has low absorbability of a liquid medium component in the solvent ink. Specifically, it is supposed that the brilliance cannot be improved by the following phenomenon.

To achieve excellent brilliance with the scaly aluminum-containing particles contained in a solvent ink, faces of the scaly aluminum-containing particles extending in the longitudinal direction are preferably aligned along the surface of a recording medium to increase the reflected light amount of light incident on the faces. However, the surface uneven layer composed of an acrylic cured resin cured by ultraviolet irradiation has very low absorbability of an organic solvent (for example, glycol ethers and lactones used as a liquid medium in a solvent ink). Thus, the liquid film formed from a solvent ink applied onto the surface uneven layer is retained for a certain period of time. During this retention, convection of a liquid medium is caused in the liquid film to increase the proportion of scaly aluminum-containing particles that are not aligned in the above manner. In such a condition, the evaporation of the liquid medium from the liquid film proceeds, and thus an intended increase in the amount of reflected light cannot be achieved in an area colored by the solvent ink.

Also on a cured product cured by other active energy rays than the ultraviolet irradiation, the above problem of the alignment of scaly aluminum-containing particles is caused if the surface uneven layer has very low absorbability of the liquid medium in a solvent.

If a highly volatile organic solvent such as methyl ethyl ketone and lower alcohols is used as the liquid medium in a solvent ink, a heating unit such as a heater can be used to rapidly evaporate the organic solvent on a recording medium to suppress the formation of a liquid film of the solvent ink. However, if a solvent ink is applied to a recording medium by an ink jet method as in the present invention, it is difficult to stably eject the solvent ink containing a highly volatile organic solvent from an ink jet head.

In the present invention, when a solvent ink containing scaly aluminum-containing particles is used to form a metallic luster surface on a surface uneven layer of a cured product prepared by ultraviolet irradiation or the like, an ink absorbing layer having absorbability of the solvent ink is provided on the surface uneven layer. Such an ink absorbing layer provided suppresses the formation of a liquid film by the application of the solvent ink to form an intended color area having a high alignment ratio of the scaly aluminum-containing particles, and metallic luster having excellent brilliance can be imparted to an uneven surface.

The above technical problem of the scaly aluminum-containing particles is also caused when flaky particles other than the scaly aluminum-containing particles are used for imparting metallic luster. If such flaky particles for imparting metallic luster are used, the advantageous effect of the invention can also be obtained by providing the above-mentioned ink absorbing layer.

The present invention will now be described in further detail with reference to preferred embodiments.

Recording Medium

In the present invention, the recording medium is not limited to particular recording media, and recording media made of various materials, such as paper and plastic films capable of being subjected to image recording using a liquid ejection head can be used. Examples of the recording medium include surface treated papers such as coated paper, art paper, and cast paper, olefinic synthetic papers, and sheets and films made from resins such as luster vinyl chloride, polyvinyl chloride including tarpaulin, polycarbonate, polyethylene terephthalate (PET), acrylic resins, polystyrene, polypropylene, polyethylene, and ABS resins.

Outline Configuration of Ink Jet Recording Apparatus

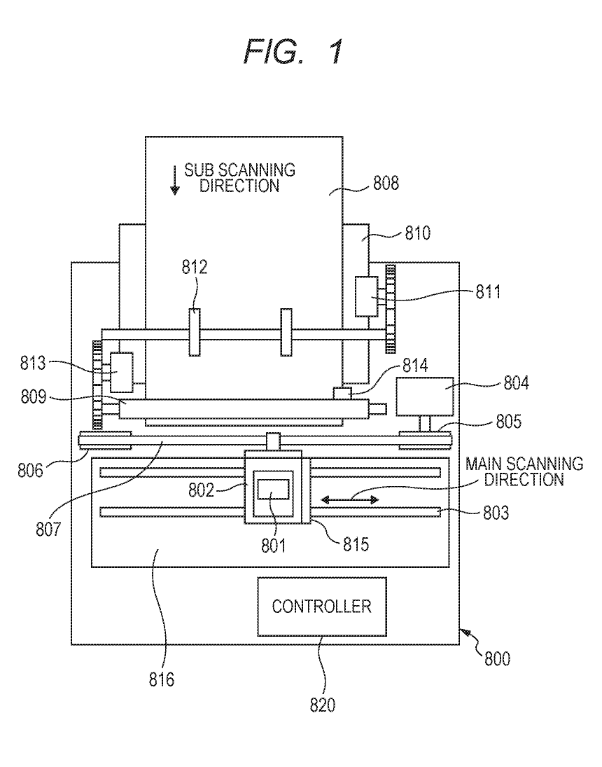

FIG. 1 is a configuration view of an ink jet recording apparatus of the present embodiment. With an ink jet recording apparatus 800, inks can be used to form a surface uneven layer, an ink absorbing layer, and a metallic luster layer and to record a color image. A head cartridge 801 is a device that ejects liquids and inks by an ink jet method and includes a liquid ejection head (not shown) having a plurality of ejection orifices and tanks (not shown) that store a liquid or an ink to be supplied to the liquid ejection head. As the tank, a cartridge type tank such as an ink cartridge having a detachable structure can be used.

The head cartridge 801 has a connector (not shown) that receives signals and the like for driving the respective ejection orifices of the liquid ejection head. Seven storage tanks are independently provided corresponding to a liquid material for forming a surface uneven layer, a liquid material for forming an ink absorbing layer, an ink for forming a metallic luster layer, and cyan, magenta, yellow, and black color inks for forming a color image. The liquid ejection head has ejection orifices corresponding to the liquids and the inks supplied from the respective storage tanks.

The head cartridge 801 is positioned and exchangeably installed on a carriage 802. The carriage 802 has a connector holder (not shown) for sending driving signals and the like to the head cartridge 801 through a connector. On the carriage 802, an ultraviolet ray irradiation device 815 is installed and is controlled in order to cure an ejected ultraviolet ray curable liquid material to fix the cured product on a recording medium. The carriage 802 can be reciprocated along a guide shaft 803. Specifically, the carriage 802 is driven by a main scanning motor 804 as a drive source through driving mechanisms including a motor pulley 805, a driven pulley 806, and a timing belt 807, and the position and the movement of the carriage are controlled. The movement of the carriage 802 along the guide shaft 803 is called “main scanning”, and this movement direction is called “main scanning direction”.

A recording medium 808 such as print paper is placed on an auto sheet feeder (hereinafter called “ASF”) 810. Alternatively, a recording medium may be fed from a media cassette (not shown) that stores a large number of recording media to the ASF.

At the time of image recording, a paper feed motor 811 is driven to rotate a pick up roller 812 through gears, and a single recording medium 808 is separated from the ASF 810 and fed. The recording medium 808 is conveyed by the rotation of a conveyor roller 809 to a recording start position facing an ejection orifice face of the head cartridge 801 on the carriage 802. The conveyor roller 809 is driven by a line feed (LF) motor 813 as a drive source through gears. The determination as to whether the recording medium 808 is fed and the confirmation of the position at the time of paper feed are performed when the recording medium 808 passes a paper end sensor 814. The head cartridge 801 installed on the carriage 802 is held in such a manner that the ejection orifice face protrudes downward from the carriage 802 and is parallel with the recording medium 808. The controller 820 includes a CPU, memory unit, and the like, receives surface uneven layer data, ink absorbing layer data, metallic luster layer data, and color image data from the outside, and controls the movement of each part of the ink jet recording apparatus on the basis of the data.

An ink absorbing layer, a metallic luster layer, and a color image layer formed by the head cartridge 801 are subjected to dry fixation treatment by a heater 816.

The liquid ejection system of the liquid ejection head used for ejecting liquid materials and inks is not limited to particular systems. Examples of the system include a system using mechanical energy to eject an ink from a liquid ejection head (piezo head) and a system using thermal energy to eject an ink from a liquid ejection head.

As the liquid ejection system of applying an active energy ray curable liquid material or a solvent ink for imparting metallic luster to a recording medium, a system using mechanical energy by an electromechanical converter, such as a piezo system is preferred in consideration of ejection stability and the degree of freedom in the design of liquid formulations, for example.

Surface uneven layer, liquid absorbing layer, metallic luster layer, and color image recording operation

A surface uneven layer, an ink absorbing layer, a metallic luster layer, and a color image recording operation in the ink jet recording apparatus having the configuration shown in FIG. 1 will next be described. First, when the recording medium 808 is conveyed to a predetermined recording start position, the carriage 802 moves above the recording medium 808 along the guide shaft 803, and during this movement, an ultraviolet ray curable liquid material is ejected from an ejection orifice on a liquid ejection head of the head cartridge 801. The ultraviolet ray irradiation device emits ultraviolet rays in accordance with the movement of the head cartridge 801 to cure the ejected liquid material, and the cured product layer is fixed on the recording medium. Next, when the carriage 802 moves to an end of the guide shaft 803, the conveyor roller 809 conveys the recording medium 808 by a predetermined distance in the direction orthogonal to the scanning direction of the carriage 802. The conveyance of the recording medium 808 is called “paper feed” or “sub scanning”, and the conveyance direction is called “paper feed direction” or “sub scanning direction”. After the completion of the conveyance of the recording medium 808 by a predetermined distance, the carriage 802 moves along the guide shaft 803 once again. The scanning of the liquid ejection head by the carriage 802 and the paper feed are repeated in this manner, forming a surface uneven layer on the whole recording medium 808. After the formation of the surface uneven layer, the conveyor roller 809 resets the recording medium 808 to the recording start position, and an ink absorbing layer, a metallic luster layer, and a color image are formed in this order on the surface uneven layer by the same process as the formation of the surface uneven layer. For simple explanation, the surface uneven layer, the ink absorbing layer, the metallic luster layer, and the color image are formed individually as described above, but a process without reset of a recording medium can be performed by controlling the injection order of ink types in each scanning so as to form the ink absorbing layer on the surface uneven layer and to form the metallic luster layer or the color image on the ink absorbing layer. Alternatively, a recording medium on which the surface uneven layer has been formed or a recording medium on which the surface uneven layer and the ink absorbing layer have been formed in this order by the above method is placed and set on the ASF 810, then is conveyed to the recording start position, and the formation of the ink absorbing layer, the formation of the metallic luster layer, and the recording of the color image can be performed as needed.

An embodiment of the image recording operation when a color image is formed will next be described.

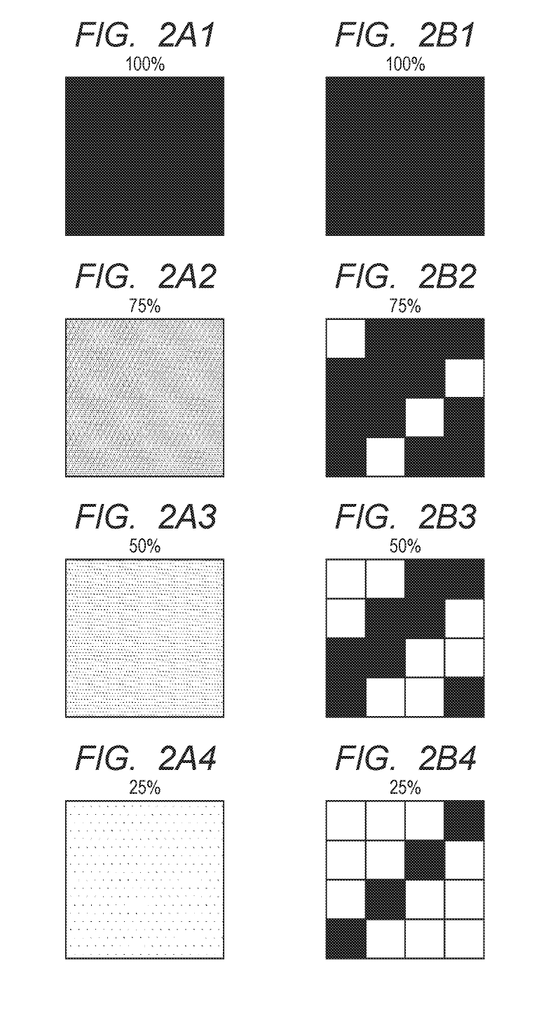

FIGS. 2A1 to 2A4 and 2B1 to 2B4 are schematic views illustrating image expressions controlled by area gradation. The A series indicated by FIGS. 2A1 to 2A4 illustrates an example of recording density gradations of 25% (FIG. 2A4), 50% (FIG. 2A3), and 75% (FIG. 2A2) where FIG. 2A1 is 100%. The B series indicated by FIGS. 2B1 to 2B4 illustrates an example of the case in which the density gradations in the A series are expressed by ink dot injection amounts into pixels.

Ejection operation of drops by a liquid ejection head is basically controlled by binary data: whether a drop is ejected or not. In the present embodiment, on/off of an ink is controlled for every pixel defined by an output resolution of an ink jet recording apparatus, and the condition where all the pixels are on in a unit area is regarded as an ink amount of 100%. With what is called a binary printer as above, a single pixel can express only 100% or 0%, and thus a half tone is expressed by an assembly of a plurality of pixels. In examples shown in FIGS. 2A1 to 2A4 and 2B1 to 2B4, a half tone expression at a density of 25% as in FIG. 2A4 is alternatively expressed by ejecting an ink at four pixels of 4×4 pixels as in FIG. 2B4, which achieves an expression of 4/16=25% in terms of area. As shown in FIGS. 2B2 and 2B3, other gradations can be similarly expressed, for example. The total number of pixels, a pattern of on-pixels, and the like in order to express half tones are not limited to the above examples. Commonly, error diffusion processing is typically used, for example. In the examples in FIGS. 2A1 to 2A4 and 2B1 to 2B4, the unit area of ink injection is divided into 4×4=16, but the number of divisions is appropriately set depending on the output resolution of an ink jet printer, for example.

In the formation of a color image in the embodiment, an ink is used in an ink application amount of more than 100% to increase the color density or to form a solid color area, in some cases. In such a case, an ink is applied to all the pixels at an ink amount of 100%, and this ink application operation at an ink amount of 100% is further repeatedly performed to all the same pixels. By repeating this operation five times, recording at an ink injection amount of 500% is achieved.

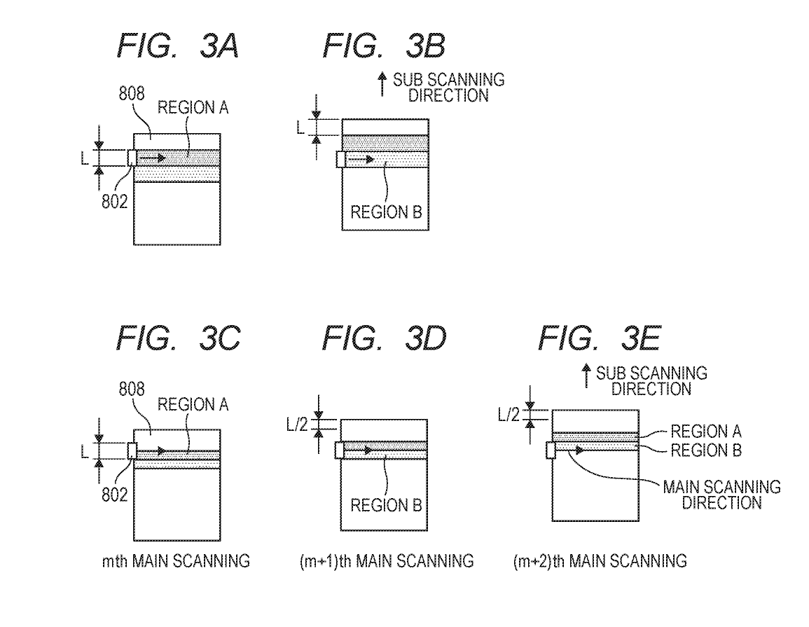

FIGS. 3A to 3E are views illustrating the operation of forming a color image by scanning of the liquid ejection head on the recording medium 808. Main scanning with the carriage 802 performs image recording only in a region with the width L of the liquid ejection head, and after every recording on a single line, the recording medium 808 is conveyed by the distance L in the sub scanning direction. For simple explanation, in this embodiment, single scanning of the ink jet recording apparatus permits the ejection of an ink only in an ink amount of at most 100%, and if the ink amount exceeds 100%, scanning is performed twice or more in the same region without conveyance. For example, if the injection ink amount is at most 500%, scanning is repeated five times on the same line. This case will be described with reference to FIGS. 3A to 3E: scanning of a region A is performed five times with the liquid ejection head (FIG. 3A); then the recording medium 808 is conveyed in the sub scanning direction; and the main scanning of a region B is repeated five times (FIG. 3B). This operation enables the formation of a 500%-injection region from the region A to the region B.

To suppress image quality deterioration such as periodic irregularity depending on the accuracy of a liquid ejection head, scanning may be performed twice or more, or what is called multipass recording may be performed even when the ink amount is 100% or less. FIGS. 3C to 3E illustrate an example of two-pass recording. In this example, main scanning with the carriage 802 performs image recording only in a region with the width L of the liquid ejection head. After the completion of every recording on a single line, the recording medium 808 is conveyed in the sub scanning direction by a distance of L/2. The region A is subjected to recording by the m-th main scanning (FIG. 3C) and the (m+1)th main scanning (FIG. 3D) of the liquid ejection head, and the region B is subjected to recording by the (m+1)th main scanning (FIG. 3D) and the (m+2)th main scanning (FIG. 3E) of the liquid ejection head. Although the operation of two-pass recording is described here, the number of passing times for recording can be changed depending on the accuracy of image quality of an intended image. When n-pass recording is performed, a recording medium 808 is conveyed in the sub scanning direction by a distance of L/n after the completion of every recording on a single line. In this case, even if the ink amount is 100% or less, a recording medium is divided into a plurality of printing patterns and main scanning with a liquid ejection head is repeated n times on the same line on the recording medium to form a color image.

By performing the above control on the ink application amount in the color image formation, the surface uneven layer, the ink absorbing layer, and the metallic luster layer can be formed.

In the formation of the surface uneven layer in the present embodiment, the above concept of the ink amount is used to control the height in each position. For the formation of the surface uneven layer, if a substantially uniform layer is formed at a liquid amount 100% (corresponding to an injection amount of 100% in FIG. 2B1), the layer has a certain thickness, or a certain height, in accordance with the volume of a liquid ejected by the liquid ejection head. For example, if the layer formed at a liquid amount of 100% has a thickness of 20 μm, the layer is layered five times to achieve a thickness of 100 μm. In other words, the amount of a liquid injected into a position required to have a height of 100 μm is 500%. If a liquid material is applied at a liquid amount of less than 100% to a unit area, a method of controlling the number of injection pixels can be used, for example, as shown in FIGS. 2B2, 2B3, and 2B4, and injection at 100% shown in FIG. 2B1 and injection at less than 100% may be combined to form at least one layer of the surface uneven layer, the ink absorbing layer, and the metallic luster layer.

The number of passing times when a multipass recording control is used, or the number of passing times for recording can be changed depending on the image quality of an image and the accuracy of a surface unevenness.

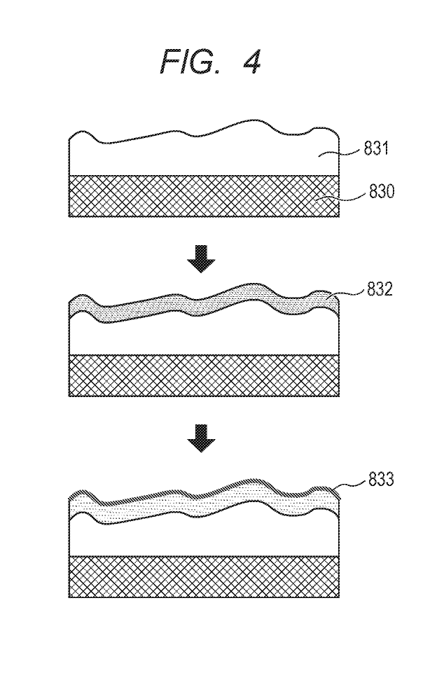

FIG. 4 is a cross-sectional view of a surface uneven layer 831, an ink absorbing layer 832, and a metallic luster layer 833 formed on a recording medium 830. In the present embodiment, on a surface uneven layer having a height distribution of at most about 1 mm, an ink absorbing layer and a metallic luster layer are formed in this order.

Surface Uneven Layer

The surface uneven layer will next be described in detail.

The surface uneven layer is formed of a cured product that is prepared by irradiating an active energy ray curable material with active energy rays. The method of forming the surface uneven layer on a recording medium is exemplified by a method in which an active energy ray curable material is used on a recording medium to form a surface uneven layer and a method in which an active energy ray curable material is used on a substrate having a surface with a corresponding uneven structure to form a surface uneven layer and the surface uneven layer is transferred and laminated onto a recording medium. To form the surface uneven layer on a recording medium or a substrate, embossing and various printing can be used. To form an uneven structure corresponding to an intended individual image, the following method can be preferably used: an active energy ray curable liquid material is applied to a recording medium by an ink jet method; and active energy rays are applied to form a surface uneven layer composed of a cured product of the liquid material. If the surface uneven layer is formed by using an ink jet method, information about application positions of an active energy ray curable liquid material by the ink jet method on a recording medium can be used in common when an ink for imparting metallic luster is applied to the recording medium.

An embodiment of forming a surface uneven layer by an ink jet method will next be described.

The surface uneven layer of the present embodiment is composed of a cured product prepared from an active energy ray curable liquid formed on a recording medium. The active energy ray curable liquid material is fed to the printer head of an ink jet recording apparatus and is ejected from the printer head to a recording medium. Then, the active energy ray curable liquid material is irradiated with active energy rays such as ultraviolet rays and electron beams to be rapidly cured on the recording medium. Specific examples of the light source of ultraviolet rays as the active energy rays include an LED lamp, a high pressure mercury lamp, a metal halide lamp, a low pressure mercury lamp, an ultrahigh pressure mercury lamp, and an ultraviolet laser. The active energy ray curable liquid material may be any material that can be irradiated with active energy rays to form a cured product having good adhesiveness on a recording medium and not causing swelling or separation even when the cured product is immersed in an organic solvent.

Ultraviolet Ray Curable Liquid Material

As the active energy rays used for curing a liquid material, ultraviolet rays are preferred from the viewpoint of versatility and handleability of an irradiation device, for example. The ultraviolet ray curable liquid material will next be described.

The ultraviolet ray curable liquid material is preferably a material containing a polymerizable compound and capable of forming a dense cured resin layer having high abrasion resistance by irradiation with ultraviolet rays.

The ultraviolet ray curable liquid material can be prepared by using a compound having polymerizability required for ultraviolet curing. The polymerizable compound is preferably radical polymerization type compounds (radical polymerizable compounds) and cationic polymerization type compounds (cationically polymerizable compounds) which cause a small change in the volume before and after curing treatment by ultraviolet irradiation.

The compound for preparing the radical polymerization type ultraviolet ray curable liquid material is exemplified by compounds having an acryloyl group. The compound for preparing the cationic polymerization type ultraviolet ray curable liquid material is exemplified by compounds having a vinyl ether group. The cured product of each material has very small absorbability of glycol ethers and lactones, which are solvent components in a solvent ink used for forming the metallic luster layer. If a piezo head is used as the liquid ejection head, the ultraviolet ray curable liquid material preferably has a viscosity of 3 to 20 mPa at the time of ejection from the liquid ejection head. To achieve this viscosity range, a polyfunctional monomer is added while a monofunctional monomer having a comparatively low viscosity is used in a large amount. Such a liquid material can have both a lower viscosity and ultraviolet curability. The ultraviolet ray curable liquid material can be prepared as a liquid material composition further containing a photopolymerization initiator and other additives, as necessary.

Polymerizable Compound

The polymerizable compound as the polymerizable component in the ultraviolet ray curable liquid material may be any compound that is polymerized upon irradiation with ultraviolet rays. The polymerizable compound itself is preferably liquid.

Specific examples of the monofunctional monomer of the polymerizable compounds include 4-hydroxybutyl acrylate, isooctyl acrylate, isobornyl acrylate, tetrahydrofurfuryl acrylate, 2-methoxyethyl acrylate, (2-methyl-2-ethyl-1,3-dioxolan-4-yl)methyl acrylate, trimethylolpropane formal acrylate, γ-butyrolactone acrylate, benzyl acrylate, 2-phenoxyethyl acrylate, and dimethyl acrylamide.

Specific examples of the polyfunctional monomer of the polymerizable compounds include 1,6-hexanediol acrylate, 1,9-nonanediol acrylate, trimethylpropane triacrylate, pentaerythritol triacrylate, trimethylpropane EO adduct triacrylate, and dendrimer acrylate.

The polymerizable compounds including the monomers exemplified in the above can be used singly or as a mixture of two or more of them.

Photopolymerization Initiator

Specific examples of the photopolymerization initiator are acyl phosphine oxides including bis(2,4,6-trimethylbenzoyl)-phenyl-phosphine oxide (Irgacure 819, manufactured by BASF Co.), bis(2,6-dimethoxybenzoyl)-2,4,4-trimethyl-pentylphenylphosphine oxide, and 2,4,6-trimethylbenzoyl-diphenyl-phosphine oxide (Lucirin TPO, manufactured by BASF Co.). Specific examples of α-hydroxyalkylphenones used as the photopolymerization initiator are 2-hydroxy-1-{4-[4-(2-hydroxy-2-methyl-propionyl)-benzyl]-phenyl}-2-methyl-propan-1-one (Irgacure 127, manufactured by BASF Co.), 2-hydroxy-4′-hydroxyethoxy-2-methylpropiophenone (Irgacure 2959, manufactured by BASF Co.), and 1-cyclohexyl phenyl ketone (Irgacure 184, manufactured by BASF Co.). A specific example of α-aminoalkylphenones used as the photopolymerization initiator is 2-benzyl-2-dimethylamino-1-(4-morpholinophenyl)-butanone-1 (Irgacure 369, manufactured by BASF Co.).

The photopolymerization initiators can be used singly or as a mixture of two or more of them.

Other Additives

The ultraviolet ray curable liquid material can contain, in addition to the polymerizable compound and the photoinitiator, various additives such as coloring materials, organic solvents, plasticizers, polymerization inhibitors, light resistant stabilizers, and antioxidants.

Formation Method of Surface Uneven Layer

The surface uneven layer can be formed as follows: for example, an ultraviolet ray curable liquid material is applied onto a recording medium by an ink jet method; then an LED that emits emission lines with a wavelength of 350 nm or more to 420 nm or less is used as the light source of ultraviolet rays to perform photoirradiation; and the ultraviolet ray curable liquid is cured on the recording medium. If the ultraviolet ray curable liquid material is prepared so as to be cured in the above-mentioned long wavelength range, a good ultraviolet curability can be achieved, and thus a surface uneven layer having excellent tackiness and abrasion resistance can be obtained. The thickness of the surface unevenness can be controlled by the method described with reference to FIGS. 2A1 to 2A4 and 2B1 to 2B4 and 3A to 3E. The surface roughness of the surface uneven layer is not limited to particular values. In order to give various metal textures such as luster texture, pear-like texture, hairline texture, and glittering texture, the surface roughness is preferably a mean uneven length Rsm of 10 μm or more to 500 μm or less and more preferably 100 μm or less. The root mean square slope RΔq is preferably 0.001° or more to 10° or less. These values are actually determined ranges of surface shapes of metallic samples, for example, available from Japan Industrial Designers' Association (JIDA), by the methods shown below. The mean uneven length Rsm and the root mean square slope RΔq are evaluation parameters of the JIS surface roughness of JIS B 0601: 2001 and are suitable for evaluation of brilliance, luster, surface treatment, and the like. The mean uneven length Rsm is determined as follows: from a roughness curve, a sample with a standard length L is extracted in the mean line direction; the length of a mean line corresponding to one peak and one valley adjacent to the peak is measured; the sum of the lengths is calculated; and the mean value is calculated. The mean uneven length Rsm is a parameter for evaluating the surface roughness in a planar direction. The root mean square slope RΔq is the root mean square of local slope angles in a standard length and is a parameter for combined evaluation of the surface roughness in a planar direction and a height direction. These evaluation parameters for surface roughness were calculated from a two-dimensional surface image measured by using a white light interference type surface shape measurement apparatus (Vert-Scan Ver. 2, 5200GML-A15: Ryoka Systems Co.).

When an uneven texture such as gold foil-like texture is added to the above various metal textures, the uneven length is preferably 100 μm or more to the difference in uneven height is preferably 10 μm or more. The uneven length is the length of a mean line corresponding to one peak and one valley adjacent to the peak on a waving curve. The difference in uneven height is a difference in height corresponding to one peak and one valley adjacent to the peak on a waving curve. This is because the uneven texture of a surface unevenness having an uneven length of 100 μm or less and a difference in uneven height of 10 μm or less is unlikely to be visually observed.

Ink Absorbing Layer

The ink absorbing layer will next be described in detail.

Resin for Forming Ink Absorbing Layer

The inventors of the present invention have studied materials for forming the ink absorbing layer formed on an area of the surface uneven layer formed on a recording medium where a solvent ink for imparting metallic luster is to be applied, and consequently have found that the following resin materials are preferred. Specific examples of the resin material for forming the ink absorbing layer include acrylic resins, urethane resins, polyester resins, vinyl acetate resins, vinyl chloride resins, and ethylene-vinyl acetate copolymer resins. A composite resin including two or more of these resins in combination can also be used as the resin material for forming the ink absorbing layer, as far as an object of the present invention can be achieved.

From the viewpoint of imparting the absorbability of the solvent ink for imparting metallic luster described later to the ink absorbing layer, the acrylic resins and the urethane resins are specifically preferably used. The ink absorbing layer is formed as a layer having the function of absorbing the solvent component in a solvent ink to separate the solvent component and flaky particles for imparting metallic luster (hereinafter called flaky particles), which are contained in the solvent ink and are to be left on the ink absorbing layer, when the ink absorbing layer absorbs the solvent ink for imparting metallic luster. Other components dissolved in the solvent component may also be absorbed into the ink absorbing layer together with the solvent component.

The form of the liquid material for forming an ink absorbing layer is exemplified by a solution type in which the resin component is dissolved in a liquid medium (solvent) and a dispersion liquid type in which the resin component is dispersed as particles in a liquid medium. Of them, the liquid material is preferably a dispersion liquid type that allows comparatively easy control of the absorbability of the solvent ink for imparting metallic luster.

As the dispersion liquid type liquid material, a resin emulsion in which resin particles (emulsion resin) are dispersed is preferred. The emulsion resin can be synthesized by a known method such as an emulsion polymerization method and an inversion emulsification method. A commercially available emulsion resin can also be used.

By selecting materials of the emulsion resin, the ink absorbing layer can obtain an appropriate surface solubility in a solvent in the solvent ink for imparting metallic luster to improve the brilliance of a metallic luster layer.

If the ink absorbing layer has an excessively low surface solubility, the start of solvent absorption of a solvent ink into the ink absorbing layer delays, thus a liquid film formed from the solvent ink is likely to be retained for a certain period of time, and the alignment properties of flaky particles deteriorate.

If the ink absorbing layer has an excessively high surface solubility, surface roughness of the ink absorbing layer or a mixed state of the ink absorbing layer and flaky particles is caused, and the alignment properties of flaky particles deteriorate. If a solution type liquid material is used to form an ink absorbing layer, the ink absorbing layer may have a higher surface solubility in the solvent component contained in a solvent ink depending on the type of the solvent component. If a dispersion liquid type liquid material is used, the ink absorbing layer has a lower surface solubility with respect to the solvent component contained in a solvent ink than that when a solution type liquid material is used, and can obtain an appropriate surface solubility. As a result, the ink absorbing layer sufficiently absorbs the solvent component in a solvent ink, and thus flaky particles can be sufficiently aligned in parallel in the metallic luster layer.

The reason why the ink absorbing layer formed from emulsion resin particles obtains an appropriate surface solubility according to the solvent in a solvent ink is supposed as follows.

The emulsion resin particles contained in a resin emulsion are particles formed by aggregation of polymer chains having relatively high molecular weights (not three-dimensionally crosslinked). It is supposed that by drying at the time of emulsion resin film formation, interfaces between emulsion resin particles themselves disappear, but an appropriate surface solubility and an appropriate permeability of solvents and the like among emulsion resin particles can be maintained because the resin is not three-dimensionally crosslinked as a resin film. In contrast, it is supposed that if a resin solution containing an oligomer or a polymer having a relatively low molecular weight is used to form an ink absorbing layer, the surface of the resulting ink absorbing layer has a relatively high solubility in a solvent, and an appropriate surface solubility cannot be obtained in some cases.

From these viewpoints, the emulsion resin is preferably an acrylic emulsion resin as acrylic resin particles and a urethane emulsion resin as urethane resin particles.

Acrylic Emulsion Resin

The acrylic emulsion resin for forming the ink absorbing layer is exemplified by an emulsion of a polymer of a (meth)acrylic acid ester and is preferably an emulsion of a polymer of an acrylic acid ester monomer. Specifically preferred is an emulsion of a (co)polymer of at least one of acrylic acid alkyl esters such as methyl acrylate, ethyl acrylate, propyl acrylate, butyl acrylate, hexyl acrylate, octyl acrylate, lauryl acrylate, and stearyl acrylate.

The acrylic emulsion resin may be a copolymer of the above (meth)acrylic acid ester monomer in combination with at least one of other monomers. The other monomer used in combination with the (meth)acrylic acid ester monomer is exemplified by acrylic acids, vinyl esters, olefins, styrenes, crotones, itacones, maleic acids, fumaric acids, acrylamides, allyl compounds, vinyl ethers, vinyl ketones, vinyl heterocyclic compounds, glycidyl esters, unsaturated nitriles, polyfunctional monomers, and various unsaturated acids.

As the acrylic emulsion resin, ES-980EA-A and ES-960MC (trade name) manufactured by Takamatsu Oil & Fat Co., Ltd., ST-200 (trade name) manufactured by Nippon Shokubai Co., Ltd., VONCOAT CF6140 and CP6190 (trade name) manufactured by Dainippon Ink and Chemicals, Inc., and Polysol OLZ-1298 (trade name) manufactured by Showa Highpolymer Co., Ltd. can be used, for example. As the emulsion of a copolymer of the acrylic emulsion resins, a styrene-acrylic copolymer emulsion, Glossdell 292-S (trade name) manufactured by Mitsui Chemicals, Inc. and a vinyl chloride-acrylic copolymer emulsion, VINYBLAN 278 (trade name) manufactured by Nissin Chemical Industry Co., Ltd. can be used, for example.

Particle Size of Resin for Forming Ink Absorbing Layer

As described above, to form the ink absorbing layer, an emulsion resin giving the following characteristics is preferably used: when the solvent ink for forming metallic luster described later is applied, the surface of the solvent absorbing layer is appropriately dissolved in a solvent component in the solvent ink and the ink absorbing layer absorbs a large amount of the solvent component. To give such characteristics, the emulsion resin preferably has the following constitution.

Particle Size

First, the particle size of such emulsion resin particles will be described. The emulsion resin particles preferably have a 50% volume average particle size (D₅₀) of 300 nm or less and more preferably 100 nm or less. If the emulsion resin particles have a 50% volume average particle size within the range, the resulting ink absorbing layer can sufficiently absorb the solvent component in a solvent ink to improve the brilliance of a metallic luster layer. In the present invention, the average particle size was determined by a common method using dynamic light scattering.

Molecular Weight

As a main factor affecting the strength of the ink absorbing layer, a degree of entanglement of resin molecular chains can be mentioned. When, for example, a plurality of recorded products each including an ink absorbing layer with insufficient strength are produced, the recorded product may be scratched even by such a slight contact that the recorded surface of a previously printed product comes in contact with the back face of a subsequently printed product. In other words, an image may have insufficient abrasion resistance.

Meanwhile, if the resin constituting emulsion resin particles has an excessively large molecular weight, the emulsion resin may have a large particle size distribution range (range of variation in particle size). In order to form a more uniform ink absorbing layer, the emulsion resin preferably has a smaller particle size distribution range.

Thus, as for the molecular weight, the resin constituting the emulsion resin particles preferably has a weight average molecular weight (Mw) of 5,000 or more to 200,000 or less in terms of polystyrene from the viewpoint of giving the strength and the uniformity of the ink absorbing layer.

Formulation of Liquid Material for Forming Ink Absorbing Layer

The method of forming the ink absorbing layer on a surface uneven layer of a recording medium may be any method that enables the formation of an intended ink absorbing layer. Preferred is a method of forming the ink absorbing layer by applying a liquid material for forming an ink absorbing layer onto the surface uneven layer of a recording medium using an ink jet method, from the viewpoint of capable of applying an intended amount of a material for forming an ink absorbing layer onto a recording medium with sufficient positional accuracy.

The formulation of the liquid material for forming an ink absorption used for application to a recording medium by an ink jet method will next be described.

Content of Resin

The content (% by mass) of the resin in a liquid material for forming an ink absorption is not limited to particular values and can be set so as to give a viscosity required for stable ejection from an intended liquid ejection head and to give formability of an ink absorbing layer on the surface uneven layer of a recording medium, for example. The content is preferably 3% by mass or more to 30% by mass or less on the basis of the total mass of the liquid material, for example.

Aqueous Liquid Medium

The liquid material for forming an ink absorbing layer can be prepared by using at least the above resin component and an aqueous medium. As the aqueous medium, water or a mixture of water and a water-soluble organic solvent is preferably used. As the water, ion-exchanged water (deionized water) is preferably used. As the water-soluble organic solvent, the following solvents can be used specifically.

Alkyl alcohols having 1 to 6 carbon atoms, such as methanol, ethanol, isopropanol, propanediol, butanol, isobutanol, butanediol, pentanol, pentanediol, and 1,2- or 1,6-hexanediol. Polyhydric alcohols such as ethylene glycol, diethylene glycol, triethylene glycol, polyethylene glycol, polypropylene glycol, glycerol, and hexanetriol. Polyhydric alcohol ethers such as ethylene glycol monoethyl ether, ethylene glycol monobutyl ether, and diethylene glycol diethyl ether. Amines such as ethanolamine and triethanolamine. These solvents can be used singly or in combination of two or more of them.

Other Components

The liquid material for forming an ink absorbing layer may contain, in addition to the above components, moisture-retaining solid components such as urea, urea derivatives, trimethylolpropane, and trimethylolethane for moisture retention. In order to make the liquid material have intended physical properties, the liquid material may contain various additives such as surfactants, anticorrosives, antifoaming agents, antiseptic agents, antifungal agents, antioxidants, reduction inhibitors, evaporation accelerators, viscosity modifiers, film forming auxiliary agents, and dispersants, as necessary.

As the surfactant, any of anionic surfactants, nonionic surfactants, and amphoteric surfactants can be used as long as the storage stability of the liquid material is not affected, for example. As the anionic surfactant, fatty acid salts, higher alcohol sulfuric acid ester salts, liquid fatty oil sulfuric acid ester salts, and alkylallylsulfonic acid salts can be specifically used, for example. As the nonionic surfactant, polyoxyethylene alkyl esters, polyoxyethylene sorbitan alkyl esters, acetylene alcohols, and acetylene glycols can be specifically used, for example.

Formation of Ink Absorbing Layer

An example of the method of forming an ink absorbing layer will next be described.

To form the ink absorbing layer on a surface uneven layer, the liquid material for forming an ink absorbing layer composed of a resin emulsion was filled in a cartridge type tank of a head cartridge in an ink jet recording apparatus, and the tank was set at a predetermined position of the head cartridge. A white PET sheet on which a surface uneven layer had been formed was set in a media cassette of the ink jet apparatus. As for the recording conditions, the number of dots per inch, or the resolution, was 600 dpi, and the recording was performed by 8-pass bidirectional recording by which an image is formed with 8-pass reciprocation. The recording duty was adjusted so that the ink absorbing layer would have an intended film thickness, and the liquid material was ejected. Then, a heater was used to volatilize volatile components contained in the liquid material at a drying temperature of 60 to 70° C., and concurrently emulsion resin particles were fused together, forming an ink absorbing layer.

Film Thickness of Ink Absorbing Layer

The layer thickness of the ink absorbing layer may be any thickness as long as the ink absorbing layer obtains an intended absorbability of a solvent ink for imparting metallic luster for achieving a desired brilliance on a metallic luster layer. In order to achieve more sufficient absorbability of a solvent ink for imparting metallic luster, the ink absorbing layer preferably has an area with a layer thickness of 10 μm or more. The upper limit of the layer thickness of the ink absorbing layer is not limited in order to give brilliance, but the ink absorbing layer preferably has an area with a layer thickness of 40 μm or less. As the ink absorbing layer has a larger thickness, the sharpness of an uneven shape of the surface uneven layer as the underlayer is reduced in some cases.

Here, the film thickness of the ink absorbing layer is a film thickness on the surface uneven layer and can be determined by observing a cross section obtained by cutting an image using an electron microscope, for example. Alternatively, the level difference between a region with an ink absorbing layer and a region without an ink absorbing layer can be measured by using a surface roughness measurement device.

Absorption Rate of Solvent Ink for Imparting Metallic Luster in Ink Absorbing Layer

The absorption rate of a solvent ink for imparting metallic luster in the obtained ink absorbing layer can be determined by using a full automatic contact angle meter (DM-701, manufactured by Kyowa Interface Science Co., Ltd.). A detailed evaluation method will be described later. The ink absorbing layer preferably has a higher absorption rate of the solvent ink. In an ink absorbing layer that completely absorbs mainly a solvent component within less than 5 minutes, a metallic luster layer exhibits high brilliance, and a high brilliance with a visual reflectance Y of 24% or more can be achieved.

Metallic Luster Layer

The metallic luster layer will next be described in detail.

Ink for Imparting Metallic Luster

An ink for imparting metallic luster (solvent ink) is prepared by dispersing flaky particles in a solvent component, as a dispersion liquid to be ejected from a liquid ejection head.

The flaky particles are exemplified by flaky aluminum-containing particles, flaky pearl pigments, and flaky organic crystals. These materials can be used singly or in combination of two or more of them.

As the flaky particles, flaky aluminum-containing particles are preferred. This is because the flaky aluminum-containing particles are aligned in parallel on a recording medium to exhibit high brilliance.

The aluminum-containing particles are exemplified by aluminum particles and aluminum alloy particles, and these materials can be used singly or in combination of two or more of them. As the aluminum-containing particles, particles prepared by pulverizing elemental aluminum (metal aluminum) or an aluminum alloy and classifying the pulverized product, as necessary, can be used.

If an aluminum alloy is used, the other metallic element added to aluminum may be any metallic elements having metallic luster and is exemplified by nickel, chromium, tin, zinc, indium, titanium, silicon, silver, and copper.

In addition to the aluminum-containing particles, other metal particles can be added as the metallic luster component in the solvent ink. Such other metal particles are exemplified by silver particles and copper-zinc alloy particles. As the other metal particles, particles prepared by pulverizing an elemental metal and classifying the pulverized product, as necessary, can be used.

The aluminum or the aluminum alloy may be interposed between protective layers. The protective layer is exemplified by a silicon dioxide layer and an acrylic resin layer.

From the viewpoint of improving the ejection performance of the solvent ink for imparting metallic luster from a liquid ejection head and improving the brilliance obtained from a metallic luster layer, the flaky aluminum-containing particles preferably have an average major axis of 0.5 μm or more to 5.0 μm or less. From the same viewpoint, the flaky aluminum-containing particles preferably have a maximum major axis of 10 μm or less. From the same viewpoint, the flaky aluminum-containing particles preferably have an average thickness of 10 nm or more to 100 nm or less. The average major axis is defined as follows: one flaky particle is observed in a substantially planar view; a maximum length of the lengths from one end to another end of the flaky particle is measured; and the average of the maximum lengths of all the flaky particles is defined as the average major axis. The maximum major axis is a maximum length of the lengths from one end to another end of a flaky particle when the flaky particle is observed in a substantially planar view. The average thickness is an average of thicknesses of all the flaky particles when each flaky particle is observed in a substantially planar view.

As the flaky aluminum-containing particles, scaly aluminum-containing particles can be preferably used. As the scaly aluminum-containing particles, high luminance Al leaf powder, product of Oike Imaging Co. and a deposition aluminum pigment, Decomet, product of Toyo Aluminium Co. can be used, for example.

The content of the flaky aluminum-containing particles in the solvent ink is preferably 2% by mass or more to 20% by mass or less. If the content is 2% by mass or less, the surface covering rate of the ink absorbing layer with the flaky aluminum-containing particles is low, and sufficient brilliance cannot be obtained in some cases. If the content is 20% by mass or more, the solvent ink has a higher viscosity, for example, and thus a stable ejection performance for ejection from a liquid ejection head cannot be obtained in some cases.

Solvent

The solvent used as the liquid component in the solvent ink for imparting metallic luster may be any solvents that satisfy the ejection performance for ejection from a liquid ejection head and can be absorbed in the ink absorbing layer formed on the surface uneven layer to form a metallic luster layer containing flaky particles aligned. Such a solvent is exemplified by organic solvents such as glycol ethers, lactones, and mixtures of them. Of them, glycol ethers are highly absorbed in the above-mentioned ink absorbing layer formed by using an acrylic emulsion resin or a urethane emulsion resin, and thus are preferred. Glycol ethers with relatively high molecular weights have high boiling points and are used as organic solvents having a small burden on the human body or the environment. Such glycol ethers can be stably ejected from a liquid ejection head and thus are considered to be preferred. Meanwhile, lactones have appropriate surface solubility and absorbability with respect to the above-mentioned ink absorbing layer formed by using an acrylic emulsion resin or a urethane emulsion resin, and thus are preferred.

Preferred examples of the glycol ethers include ethylene glycol ethers and propylene glycol ethers having an aliphatic group such as methyl, n-propyl, i-propyl, n-butyl, i-butyl, hexyl, and 2-ethylhexyl groups; an allyl group with a double bond; and a phenyl group. More specifically, preferred examples include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and tetraethylene glycol dimethyl ether. These solvents can be used singly or in combination of two or more of them.

Preferred examples of the lactones include γ-butyrolactone, δ-valerolactone, and ε-caprolactone. These solvents can be used singly or in combination of two or more of them.

Other Additives

As a dispersant of the flaky particles, cellulose acetate butyrate may be used. The cellulose acetate butyrate has a function of dispersing flaky particles in a solvent and also has a function of allowing flaky particles to come close to each other in an ink film to help parallel alignment. As the cellulose acetate butyrate, a product of Eastman Kodak Co. and a product of Kusumoto Chemicals Co. can be used. In order to make the solvent ink have intended physical properties, the solvent ink may contain, as other components, at least one of various additives such as dispersants, surfactants, anticorrosives, antifoaming agents, antiseptic agents, antifungal agents, antioxidants, reduction inhibitors, evaporation accelerators, viscosity modifiers, and film forming auxiliary agents, as necessary.

Formation Method of Metallic Luster Layer

An example of the method of forming a metallic luster layer will next be described.

To form the metallic luster layer on the ink absorbing layer, the ink for imparting metallic luster was filled in a storage tank of a head cartridge in an ink jet recording apparatus, and the tank was set at a predetermined position of the head cartridge. A white PET sheet on which a surface uneven layer and an ink absorbing layer had been formed was set in a media cassette of the ink jet apparatus. As for the recording conditions, the number of dots per inch, or the resolution was 600 dpi, and the recording was performed by 8-pass bidirectional recording by which an image was formed with 8-pass reciprocation. The ink for imparting metallic luster was ejected at a recording duty of 100%. A heater was used to volatilize volatile components from the ink at a drying temperature of 40 to 50° C., and concurrently the ink was rapidly absorbed into the ink absorbing layer. By this operation, the flaky particles were aligned in parallel on the ink absorbing layer, and the flaky particles were bonded to each other to form a metallic luster layer. Consequently, the formed metallic luster layer can exhibit high brilliance.

The metallic luster layer is preferably formed so as to give a visual reflectance Y of at least 24%, which will be described later.

Color Image

The inks and the formation method of a color image may be any inks that can be ejected with an ink jet recording apparatus and any formation methods usable in an ink jet recording apparatus. As the ink for color images, an ink prepared by adding a pigment and/or a dye to the solvent ink for imparting metallic luster and an ink prepared by dispersing, in a solvent for a solvent ink, aluminum-containing particles having a surface colored with a pigment or a dye can also be used. A method in which an ink is applied to the surface of a metallic luster layer by an ink jet method or the like to color the surface a predetermined color is used to record a color image. A part of a recording medium is left as a region in which no metallic luster layer is formed, and inks for color images are used to form a color image in this region. The region in which no metallic luster layer is formed can be formed in a part selected from an exposed surface of the recording medium, the surface uneven layer, and the ink absorbing layer. As described above, the metallic luster layer and the color image can be formed at the same time.

### EXAMPLES

The present invention will be described in further detail with reference to examples and comparative examples, but the invention is not intended to be limited to these examples.

### Example 1

Ultraviolet Ray Curable Ink

As an ultraviolet ray curable liquid material, a mixture of 68% by mass of dimethyl acrylamide as a monofunctional monomer, 27% by mass of dendrimer acrylate as a polyfunctional monomer, and 2% by mass of Irgacure 819 and 3% by mass of Lucirin TPO as initiators was used.

Formation of Surface Uneven Layer

First, in a cartridge type tank of a head cartridge in the ink jet recording apparatus shown in FIG. 1, the ultraviolet ray curable liquid material prepared as above was filled, and the tank was set at a predetermined position of the head cartridge. As a recording medium, a white PET sheet (trade name: E20, manufactured by Toray Industries Inc.) was prepared and set in a media cassette in the ink jet apparatus. As for the recording conditions, the number of dots per inch, or the resolution, was 1,200 dpi, and the recording was performed by 8-pass bidirectional recording by which an image was formed with 8-pass reciprocation. By using an image in which the recording duty was changed from 0% to 100%, a surface uneven layer was prepared.

Resin-Containing Liquid Material

As a liquid material for forming an ink absorbing layer, 30% by mass of diethylene glycol diethyl ether, 20% by mass of isopropanol, and 30% by mass of water were mixed with 20% by mass of an acrylic emulsion (ES-980EA manufactured by Takamatsu Oil & Fat Co., Ltd.) to prepare a dispersion liquid. The dispersion liquid had a viscosity of about 3 mPa. For the viscosity measurement, an MCR300 rheometer manufactured by Anton Paar Co. was used.

Formation of Ink Absorbing Layer

Next, in order to form an ink absorbing layer on the surface uneven layer, the liquid material for forming an ink absorbing layer prepared as above was filled in a cartridge type tank in the ink jet recording apparatus, and the tank was set at a predetermined position of the head cartridge. A white PET sheet on which a surface uneven layer had been formed was set in a media cassette of the ink jet apparatus. As for the recording conditions, the number of dots per inch, or the resolution, was 600 dpi, and the recording was performed by 8-pass bidirectional recording by which an image was formed with 8-pass reciprocation. An image with a recording duty of 100% was formed, then a print heater was used to volatilize the solvent at a drying temperature of 60 to 70° C., and an ink absorbing layer was prepared. The ink absorbing layer had a film thickness of 10 μm.

Solvent Ink for Imparting Metallic Luster

As scaly aluminum-containing particles, a dispersion liquid of aluminum-containing particles (Oike Imaging, high luminance Al leaf powder) in which scaly particles prepared by pulverization of a deposited aluminum film were dispersed in butyl acetate was subjected to centrifugal separation to remove coarse particles, giving a dispersion liquid of aluminum-containing particles having an average particle size of 1 μm and a maximum particle size of 10 μm or less. The scaly aluminum-containing particles had an average thickness of 20 nm or more to 40 nm or less. By controlling organic solvent components, a solvent ink for imparting metallic luster containing 70% by mass of diethylene glycol diethyl ether, 15% by mass of tetraethylene glycol dimethyl ether, 10% by mass of γ-butyrolactone, and 5% by mass of scaly aluminum-containing particles was obtained.

Formation of metallic luster layer

In order to form a metallic luster layer on the ink absorbing layer, the solvent ink for imparting metallic luster prepared as above was filled in a cartridge type tank in the ink jet recording apparatus, and the tank was set at a predetermined position of the head cartridge. As for the recording conditions, the number of dots per inch, or the resolution, was 600 dpi, and the recording was performed by 8-pass bidirectional recording by which an image was formed with 8-pass reciprocation. The ink was ejected at a recording duty of 100% to form a metallic luster layer, yielding a printed product.

### Examples 2 to 15

Printed products were obtained in the same manner as in Example 1 except that the corresponding liquid materials for forming an ink absorbing layer and the layer thicknesses of the ink absorbing layer shown in Table 1 were used.

TABLE 1

| | | Layer thickness |
|---|---|---|
| | Resin material for forming ink | of ink |
| Example | absorbing layer | absorbing layer |
| 1 | Acrylic emulsion | 10 μm |
| | (ES-980EA manufactured by Takamatsu | |
| | Oil & Fat) | |
| 2 | Acrylic emulsion | 10 μm |
| | (trade name: Polysol OLZ-11298, | |
| | manufactured by Showa Highpolymer) | |
| 3 | Urethane emulsion | 10 μm |
| | (trade name: HW171, manufactured by | |
| | DIC) | |
| 4 | Urethane emulsion | 10 μm |
| | (trade name: RS1, manufactured by DIC) | |
| 5 | Acrylic emulsion | 30 μm |
| | (ES-980EA manufactured by Takamatsu | |
| | Oil & Fat) | |
| 6 | Acrylic emulsion | 19 μm |
| | (ES-980EA manufactured by Takamatsu | |
| | Oil & Fat) | |
| 7 | Acrylic emulsion | 14 μm |
| | (ES-980EA manufactured by Takamatsu | |
| | Oil & Fat) | |
| 8 | Acrylic emulsion | 9 μm |
| | (ES-980EA manufactured by Takamatsu | |
| | Oil & Fat) | |
| 9 | Acrylic emulsion | 7 μm |
| | (ES-980EA manufactured by Takamatsu | |
| | Oil & Fat) | |
| 10 | Acrylic emulsion | 10 μm |
| | (trade name: ST-100, manufactured by | |
| | Nippon Shokubai) | |
| 11 | Acrylic emulsion | 10 μm |
| | (trade name: ES-980MC, manufactured by | |
| | Takamatsu Oil & Fat) | |
| 12 | Acrylic emulsion | 10 μm |
| | (trade name: VONCOAT CF6410, | |
| | manufactured by DIC) | |
| 13 | Acrylic emulsion | 10 μm |
| | (trade name: VINYBLAN 278, | |
| | manufactured by Nissin Chemical | |
| | Industry) | |
| 14 | Urethane emulsion | 10 μm |
| | (trade name: UCOAT UWS-145, | |
| | manufactured by Sanyo Chemical | |
| | Industries) | |
| 15 | Urethane emulsion | 10 μm |
| | (trade name: PERMARIN UA-200, | |
| | manufactured by Sanyo Chemical | |
| | Industries) | |

### Comparative Example 1

A printed product was obtained in the same manner as in Example 1 except that no ink absorbing layer was formed.

### Comparative Example 2

A printed product was obtained in the same manner as in Comparative Example 1 except that the drying temperature of the solvent ink for imparting metallic luster on the recording medium was increased to 100° C.

### Comparative Example 3

A printed product was obtained in the same manner as in Comparative Example 1 except that the irradiation intensity of ultraviolet rays was reduced to 10 mJ/cm² and the surface uneven layer was not completely polymerized.

### Comparative Example 4

A printed product was obtained in the same manner as in Comparative Example 1 except that the ultraviolet ray curable ink used was a mixture of 40% by mass of dimethyl acrylamide as a monofunctional monomer, 40% by mass of Biscoat #150D as a polyfunctional oligomer, 15% by mass of diethylene glycol diethyl ether as a dilution solvent, and 2% by mass of Irgacure 819 and 3% by mass of Lucirin TPO as initiators.

Evaluation of absorption rate of solvent ink for imparting metallic luster and brilliance and abrasion resistance of metallic luster image

The absorption rates of the solvent ink for imparting metallic luster in the ink absorbing layers used in Examples 1 to 15 and Comparative Examples 1 to 4, and the brilliance and abrasion resistance of the obtained metallic luster images were evaluated by the following methods. The obtained evaluation results are shown in Table 2.

Ink Absorption Rate

The absorption rate of the solvent ink for imparting metallic luster in the ink absorbing layer was determined by using a full automatic contact angle meter (DM-701, manufactured by Kyowa Interface Science Co., Ltd.). As the sample for evaluation, various resin-containing liquid materials to be evaluated as the ink absorbing layer were applied by a bar coater onto OK Top Coat papers manufactured by Oji Paper Co., Ltd. and dried to form ink absorbing layers having corresponding layer thicknesses. Onto the sample for evaluation, 1 μl of the solvent ink for imparting metallic luster prepared in accordance with Example 1 was dropped, and the cross section was observed with a camera for the time period until the liquid component of the ink was completely absorbed. To drop the ink, a glass injection needle with a teflon coated needle, 18G manufactured by Kyowa Interface Science Co., Ltd. was used, and to observe a cross section of an ink droplet, a droplet observation function on the surface of a sample for evaluation with a full automatic contact angle meter (DM-701) was used. White light was applied to the sample for evaluation from the back side, a change of the droplet on the sample for evaluation was observed with time by using an observation camera placed across the sample in a 180-degree direction. When 1 μL of the solvent ink for imparting metallic luster was dropped onto a simple OK Top Coat paper used as the recording medium of the sample for evaluation, the ink was adsorbed within several seconds or less, which had little effect on the evaluation of the ink absorbing layer on the recording medium. The criteria of the ink absorption rate are as shown below.
4: less than 5 minutes until the ink is completely absorbed (less than 5 min/1 μL)
3: not less than 5 minutes and less than 10 minutes
2: not less than 10 minutes and less than 20 minutes
1: not less than 20 minutes

Brilliance

The regular reflectance of the printed product obtained in the above was measured by using a microspectroscope (LVmicroV, manufactured by Lambda Vision Inc.). As the intensity of regular reflectance, the Y value representing visual reflectance was used. Measurement was performed at 10 points in each printed product face, and the average was calculated for evaluation. The criteria of brilliance are as shown below.
3: the visual reflectance Y is 24% or more to the brilliance is high.
2: the visual reflectance Y is not less than 10% and less than 24%, and the brilliance is within an acceptable range.
1: the visual reflectance Y is less than 10%, and the brilliance is low.

Abrasion Resistance

The metallic luster surface of the printed product obtained in the above was rubbed once with an index finger in a direction, and the change was visually observed for evaluation.
3: the original metallic luster surface is not spread to the periphery (good fixability).
2: the metallic luster surface is spread, but the brilliance is not apparently changed.
1: the original brilliance of the metallic luster surface deteriorates (poor fixability).

TABLE 2

| | Ink absorption | | Abrasion |
|---|---|---|---|
| | rate | Brilliance | resistance |
| Example 1 | 4 | 3 | 3 |
| Example 2 | 4 | 3 | 3 |
| Example 3 | 4 | 3 | 3 |
| Example 4 | 4 | 3 | 3 |
| Example 5 | 4 | 3 | 3 |
| Example 6 | 4 | 3 | 3 |
| Example 7 | 4 | 3 | 3 |
| Example 8 | 3 | 2 | 3 |
| Example 9 | 3 | 2 | 2 |
| Example 10 | 3 | 2 | 3 |
| Example 11 | 3 | 2 | 3 |
| Example 12 | 2 | 2 | 3 |
| Example 13 | 2 | 2 | 3 |
| Example 14 | 3 | 2 | 3 |
| Example 15 | 3 | 2 | 3 |
| Comparative | 1 | 1 | 1 |
| Example 1 | | | |
| Comparative | 1 | 1 | 1 |
| Example 2 | | | |
| Comparative | 1 | 1 | 1 |
| Example 3 | | | |
| Comparative | 1 | 1 | 1 |
| Example 4 | | | |

As shown in Table 2, the printed products in Examples 1 to 7 have high ink absorption rates, good brilliance, and good abrasion resistance. The printed products in Examples 8 to 15 have lower ink absorption rates than those of Examples 1 to 7 and have low brilliance, which are within an acceptable range. In contrast, the printed products in Comparative Examples 1 to 4, in which no ink absorbing layer was formed, have very low ink absorption rates, low brilliance, and poor abrasion resistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-108940, filed May 28, 2015, which is hereby incorporated by reference herein in its entirety.

1. A method of recording an image including an uneven surface having metallic luster on a recording medium, the method comprising the steps of:
forming on a recording medium a surface uneven layer of a cured product produced by irradiating an active energy ray curable material with an active energy ray;
forming an ink absorbing layer on the surface uneven layer; and
applying to the ink absorbing layer an ink containing flaky particles for imparting metallic luster by an ink jet method.

2. The method according to claim 1, wherein the ink absorbing layer contains at least one of an acrylic resin and a urethane resin.

3. The method according to claim 2, wherein the ink absorbing layer is formed by applying a liquid material containing at least one kind of resin particles selected from the group consisting of acrylic resin particles and urethane resin particles to the surface uneven layer.

4. The method according to claim 3, wherein the liquid material containing the resin particles is applied by an ink jet method.

5. The method according to claim 1, wherein the ink absorbing layer has a thickness of 10 μm or more.

6. The method according to claim 1, wherein the ink absorbing layer has an absorption rate of the ink for metallic luster of less than 5 min/1 μL.

7. The method according to claim 1, wherein the active energy ray curable liquid material contains a radically polymerizable compound having an acryloyl group or a cationically polymerizable compound having a vinyl ether group.

8. The method according to claim 1, further comprising a step of applying an active energy ray to the active energy ray curable liquid material applied by using an ink jet method on the recording medium to form the surface uneven layer of a cured product of the liquid material.

9. The method according to claim 1, wherein the flaky particles are flaky aluminum-containing particles.
